(19) United States
(12) Patent Application Publication
(10) Pub. No.: US 2012/0085432 A1
(43) Pub. Date: Apr. 12, 2012

(54) Suicide Resistant Faucet

(76) Inventor: Patrick E. Keller, Virgina Beach, VA (US)

(21) Appl. No.: 13/253,864

(22) Filed: Oct. 5, 2011

Related U.S. Application Data
(60) Provisional application No. 61/390,494, filed on Oct. 6, 2010.

(51) Int. Cl. F16K 51/00

(52) U.S. Cl. 137/343

(57) ABSTRACT

A device for making projecting elements, such as faucet handles, suicide resistant comprising a fixture free of hanging points which is provided with one or more lumens which are adapted to house one or more projecting elements in such a manner that such elements cannot be used as a point of attachment for a rope, belt or similar means for committing suicide by hanging.

### CROSS-REFERENCE TO RELATED APPLICATIONS

This application claims benefit under 35 U.S.C. §119(e) from U.S. Provisional Patent application No. 61/390,494, filed on Oct. 6, 2010, the entirety of which is incorporated by reference herein. This application is also related to application Ser. No. 12/505,352, filed Jul. 17, 2009 and titled “Sentinel Event Reducing Safety Knobs”, which has been published as published application no. 2010/0013248; U.S. application Ser. No. 12/260,010, filed Oct. 28, 2008 which has been published as published application no. 2010/0101149 entitled “Suicide Prevention Device” and U.S. Pat. No. 7,024,823, the disclosure of each of which is incorporated herein by reference in its entirety.

### BACKGROUND OF THE INVENTION

The present invention relates to a faucet assembly adapted to significantly reduce or eliminate the occurrence of sentinel events, i.e., suicide and/or self-inflicted injuries, and more particularly, but not exclusively, two faucet assemblies having particular constructions that prevent and/or remove the physical means which a conventional faucet would provide for an individual to hang him or herself. Medical facilities are aware that some of their patient population is at risk of committing suicide, specifically by hanging, while being treated in the medical facility. These suicides, referred to in the industry as sentinel events, often occur either in the bathroom or shower facility of a medical institution. Such bathrooms typically have sinks with faucets which faucets can be used as a means for tethering a belt, a piece of cloth, a rope or similar means to aid in committing suicide by hanging.

Furthermore, every bathroom, shower facility and the like in a medical institution cannot be watched continuously and at the same time without the use of enormous staff resources. Therefore, bathrooms, shower facilities and the like, and specifically, faucets, provide a location of opportunity for a sentinel event for patients to attempt suicide.

To address the need for eliminating faucets as a site for suicide attempts, the present invention provides a faucet assembly which effectively forecloses such use. While the present invention is, in its preferred embodiment, directed to neutralizing faucets as a means for assisting suicide attempts, it should be understood that the present invention is also applicable to other projections having a configuration which could be addressed by the present invention to render them suicide resistant. For example, such common projections as radiator valves, electrical fixtures (particularly those on walls), door handles and other such elements may be made suicide resistant by application of the principles of the present invention.

A preferred embodiment of the present invention will be described below in some detail, but those skilled in the art will understand from the principles described below how to apply the present invention to faucets having different shapes than those described herein and to other projections which might otherwise be used to assist a suicide attempt.

### BRIEF DESCRIPTION OF THE DRAWINGS

FIG. 1 illustrates a metering faucet prior to the addition of a device made according to the present invention to make it suicide resistant.

FIG. 2A illustrates, in perspective, an embodiment of the present invention viewed from above.

FIG. 2B illustrates a top view of the device shown in FIG. 2A.

FIG. 2C illustrates a side view of the device shown in FIG. 2A.

FIG. 3 illustrates the device of the present invention assembled over a metering faucet to render it suicide resistant.

FIGS. 4A and 4B illustrate an alternate embodiment of the device of the present invention.

It should be noted that the figures are not drawn to scale and that elements of similar structures or functions are generally represented by like reference numerals for illustrative purposes throughout the figures. It should also be noted that the figures are only intended to facilitate the description of the disclosed embodiments. The figures do not illustrate every aspect the disclosed embodiments and do not limit the scope of the disclosed embodiments.

### DESCRIPTION OF PREFERRED EMBODIMENTS

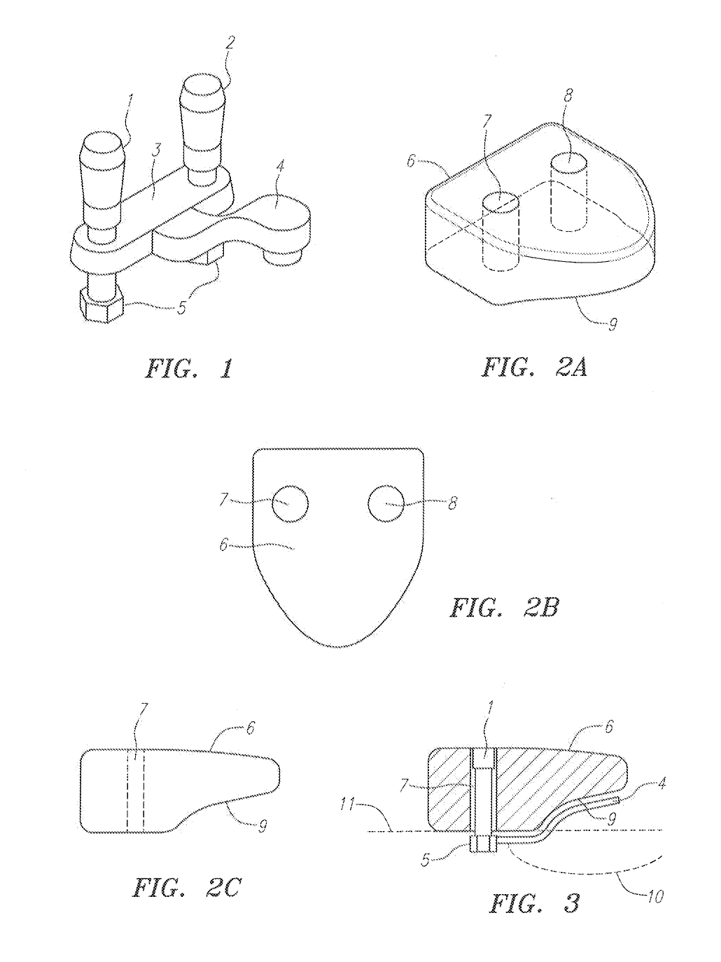

FIG. 1 illustrates a metering faucet of the type available from Chicago Faucet as part number 802-665CP, which is a deck-mounted, 4-inch, center set metering faucet. A similar faucet is available from American Standard as part number 1340.225.002. Such faucets have plungers 1 and 2 which can he depressed to deliver hot and cold water, respectively. The water passes through mixing chamber 3 and is delivered from faucet element 4. The faucet is provided with threaded elements 5 so that it can be attached to the appropriate plumbing fixtures.

FIG. 2A illustrates an embodiment of the present invention which comprises a body 6 made from cast porcelain or any other suitable material such as plastic or metal. Preferably, this material will have a solid surface. However, porcelain is preferred. The external shape of the suicide resistant fixture may be virtually any shape which is compatible with the space and the configuration of the faucet with which it will he combined and which has no hanging points. As shown, the suicide resistant fixture of FIG. 2A is roughly triangular or spade shaped. Other features are lumens 7 and 8 which are sized to fit over plungers 1 and 2 shown in FIG. 1 with the upper ends of the plungers being either flush with the upper surface of body 6 or some acceptable distance below that surface. The primary considerations relating to the locations of the upper ends of plungers 1 and 2 with respect to the upper surface of body 6 are that they provide no purchase for a rope, belt or other means which could be used for suicide by hanging, but at the same time be adequately accessible so that a user can depress them to cause the delivery of water. Body 6 is also provided with back wall 8 which is to be installed flush with a wall or back splash surface such that it is not possible to insert a rope or the like between the fixture and the wall. In addition, the front end of body 6 is provided with a curved surface 9 to accommodate faucet element 4.

FIG. 2B is a top view of suicide resistant fixture 6 showing its top surface and lumens 7 and 8.

FIG. 2C is a side view of suicide resistant fixture 6 showing lumen 7 and curved surface 9.

FIG. 3 is a cross-sectional view showing body 6 having lumen 7 which now surrounds plunger 1 and also showing faucet 4 in relation to curved surface 9. Threads 5 are also shown. Dotted line 10 represents the basin of a sink and dotted line 11 represents the countertop of a sink.

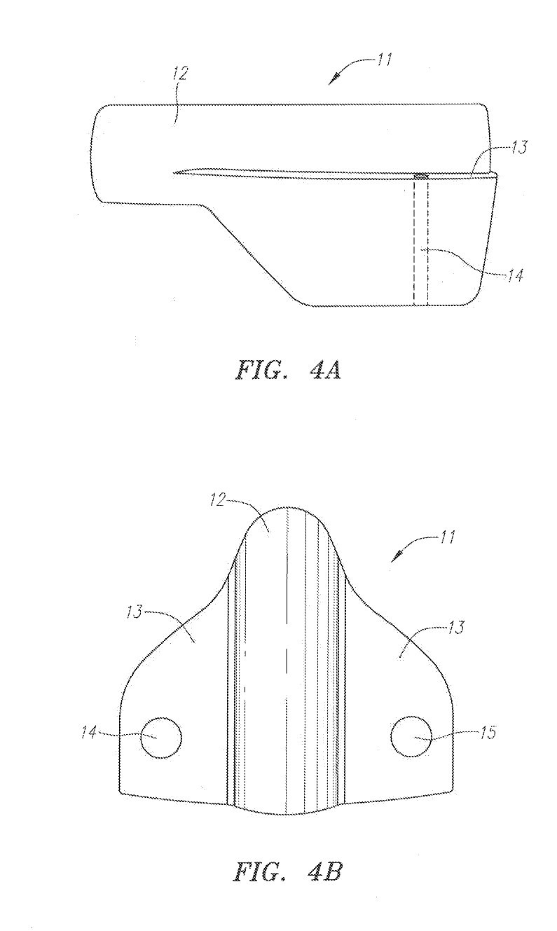

FIGS. 4A and 4B show another embodiment of the present invention which is designed for use with an 8″ Chicago metering faucet or other faucets of similar design. Its external shape is somewhat different but it functions on the same principle as the device shown in FIGS. 2A-3. In this embodiment, as shown in FIGS. 4A. and 4B, the suicide resistant device 11 has a raised central portion 12 and two laterally extending portions 13. The laterally extending portions 13 are provided with lumens 14 and 15. Once again, lumens 14 and 15 are adapted to accommodate the plungers of a faucet n the same manner as that shown in FIG. 3 to make them suicide resistant.

In the preferred embodiments of the present invention, the suicide resistant fixture will he made of a high-impact, solid-surface material and customized to fit the sink and faucet with which it will be used. Push button metering valves, which conserve water, and which require no battery or calibration are also preferred. Such faucets provide all three types of water temperature, i.e., hot, cold and warm for the user. Most importantly, once the suicide resistant fixture of the present invention is assembled with a faucet for which it is suited, there will be no protrusions and therefore no hanging points to which a rope or the like might be tied or looped. In installing the suicide resistant fixture of the present invention, care should be taken to remove any imperfections, particularly with regard to the back wall 8 of the device. Thus, if sanding or other modification of the back wall $ to accommodate the wall or back splash next to which it is to be installed is required, such reconfiguration should be accomplished before installation.

Once this is accomplished, the suicide resistant fixture and the faucet can be assembled and the faucet can then be attached to appropriate plumbing fixtures in the manner recommended by the faucet manufacturer.

As will be apparent through those skilled in the art from the foregoing description, the present invention provides a suicide resistant device which can be configured to render a variety of different types of projecting elements suicide resistant. For example, if the faucet to be protected has only a single plunger as in the case of the Moen 8884 M-Press One-handle metering faucet, only one lumen in the device will be needed. Similarly, the suicide resistant device of the present invention may be configured to accommodate radiator valves, wall fixtures for lamps or other electrical devices, or door handles, or any other projecting element for which suicide resistance protection is desired.

Thus, the present invention is not limited to the foregoing embodiments but is of the full scope of the claims appended hereto.

1. A suicide resistant fixture adapted for combination with a projecting element comprising a body which has no hanging points and at least one lumen in said body adapted to surround a projecting element such that the projecting element is sufficiently recessed into the lumen so that the use of the projection as a hanging point is substantially reduced.

2. The device of claim 1 wherein said device is adapted to be used with a faucet.

3. The device of claim 2 wherein said device has two lumens.

4. An assembly comprising a projecting element and a suicide resistant device wherein said suicide resistant device has no hanging points and said suicide resistant device has at least one lumen which surrounds a projecting element such that the upper surface of the projection has a height which is no more than flush with the upper surface of the suicide resistant device.

5. The assembly of claim 4 wherein the projecting element is recessed within the lumen.

6. The assembly of claim 5 wherein the projecting element is capable of being activated to deliver water from a faucet.

7. The assembly of claim 6 wherein said projecting element is a plunger.

8. The assembly of claim 7 wherein said suicide resistant device has at least part of its lower surface configured to accommodate the delivery portion of a faucet.

9. The assembly of claim 5 wherein the projecting element is selected from the group consisting of a radiator valve, door handle and an electrical fixture.
